(19) United States
(12) Patent Application Publication
(10) Pub. No.: US 2026/0342513 A1
(43) Pub. Date: Oct. 29, 2026

(54) TRANSMISSION OF TRACKING REFERENCE SIGNALS

(71) Applicant: NOKIA TECHNOLOGIES OY, Espoo (FI)

(72) Inventors: Timo KOSKELA, Oulu (FI); Sami-Jukka HAKOLA, Oulu (FI); Juha Pekka KARJALAINEN, Sotkamo (FI); Mihai ENESCU, Espoo (FI); Sanjay GOYAL, Denville, NJ (US)

(21) Appl. No.: 19/191,637

(22) Filed: Apr. 28, 2025

(51) Int. Cl. H04L 5/00; H04W 72/232

(52) U.S. Cl. CPC H04L 5/005; H04W 72/232

(57) ABSTRACT

Various embodiments of the present disclosure include apparatuses, systems, and/or methods for transmission of tracking reference signals (TRSs). An apparatus may comprise at least one processor; and at least one memory storing instructions that, when executed by the at least one processor, cause the apparatus at least to perform: receiving, by a terminal device and from a network device, a downlink control information (DCI) message triggering a semi-persistent tracking reference signal (spTRS); receiving, by the terminal device, information comprising one or more adaptation indications for the spTRS, wherein the one or more adaptation indications comprise at least one of bandwidth (BW) indications or periodicity indications; changing, based on the one or more adaptation indications, at least one of the BW or the periodicity; and/or tracking, based on a reduction of periodicity or an increase in BW, at least one of time or frequency of a channel.

### TECHNICAL FIELD

Various example embodiments relate generally to transmission of tracking reference signals (TRSs).

### BACKGROUND

In at least some technologies, for example, such as 5G technologies, aTRSs associated with periodic TRSs. For example, an aTRS is not transmitted without its associated periodic TRS. In some examples, a terminal device (e.g., user equipment (UE)) rely on a configuration of a periodic TRS as a quasi co-location (QCL) source.

### BRIEF DESCRIPTION

Various embodiments of the present disclosure relate to apparatuses, systems, and methods for transmission of TRSs. For example, in some embodiments, an apparatus may comprise at least one processor and at least one memory comprising instructions that, when executed by the at least one processor, cause the apparatus at least to perform: (i) receiving, by a terminal device and from a network device, a downlink control information (DCI) message triggering a semi-persistent tracking reference signal (spTRS); (ii) receiving, by the terminal device, information comprising one or more adaptation indications for the spTRS, wherein the one or more adaptation indications comprise at least one of bandwidth (BW) indications or periodicity indications; (iii) changing, based on the one or more adaptation indications, at least one of the BW or the periodicity; and/or (iv) tracking, based on a reduction of periodicity or an increase in BW, at least one of time or frequency of a channel. In some embodiments, the instructions, when executed by the at least one processor, further cause the apparatus at least to perform: indicating, by the terminal device and prior to the changing, an increased modulation and coding scheme (MCS) based on one or more conditions of the channel. In some embodiments, the apparatus is a terminal device, for example, such as a user equipment (UE).

According to one aspect, there is provided an apparatus comprising at least one processor and at least one memory comprising instructions that, when executed by the at least one processor, cause the apparatus at least to perform: (i) receiving, by a terminal device and from a network device, configuration information for configuring a radio network temporary identifier (RNTI) for monitoring aperiodic tracking reference signal (aTRS) triggering; and/or (ii) configuring the RNTI for monitoring aTRS triggering. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the configuration information further comprises configuration information for configuring the terminal device with a specific RNTI for monitoring the aTRS triggering. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the specific RNTI is an A-RNTI. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the instructions, when executed by the at least one processor, further cause the apparatus at least to perform: (i) receiving, by the terminal device, a downlink control information (DCI) transmission; (ii) detecting that the DCI was transmitted using an RNTI; and/or (iii) indicating, based on information provided by the DCI, transmission of an aTRS. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the detecting is based on a format of the DCI having cyclic redundancy check (CRC) that is scrambled with A-RNTI. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the configuration information further comprises configuration information for configuring the terminal device to monitor at least one of: a first DCI format comprising aTRS information or a second DCI format indicating downlink resource allocation. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the instructions, when executed by the at least one processor, further cause the apparatus at least to perform: determining, based on the second DCI format, to reinterpret one or more fields of the DCI to be applicable for aTRS. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, one or more fields of the DCI are set to specific values to indicate that the DCI is configured to trigger aTRS. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the configuration information further comprises configuration information for configuring the terminal device to monitor for A-RNTI and cell RNTI (C-RNTI) for monitoring the aTRS triggering. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the monitoring the aTRS triggering is based on a DCI format indicating TRS triggering. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the configuration information further comprises configuration information for configuring the terminal device to monitor the aTRS triggering using one or more dedicated search spaces. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the configuration information further comprises configuration information for configuring the terminal device to monitor the aTRS triggering using at least one of A-RNTI or C-RNTI. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the instructions, when executed by the at least one processor, further cause the apparatus at least to perform: (i) detecting a DCI format, transmitted with at least one of A-RNTI or C-RNTI, on the one or more dedicated search spaces; and/or (ii) indicating the aTRS triggering using one or more parameters. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the instructions, when executed by the at least one processor, further cause the apparatus at least to perform: using a most recent triggered aTRS as a quasi co-location (QCL) source for one or more downlink (DL) transmissions. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the instructions, when executed by the at least one processor, further cause the apparatus at least to perform: using, by the terminal device, one or more specific TRS configurations based on a type of RNTI used for transmitting a TRS trigger. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the type of RNTI is at least one of A-RNTI or C-RNTI. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the instructions, when executed by the at least one processor, further cause the apparatus at least to perform: using, by the terminal device, one or more first TRS configurations based on the RNTI being C-RNTI. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the instructions, when executed by the at least one processor, further cause the apparatus at least to perform: using, by the terminal device, one or more second TRS configurations based on the RNTI being A-RNTI. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the instructions, when executed by the at least one processor, further cause the apparatus at least to perform: using, by the terminal device, an indicated transmission configuration indicator (TCI) state as a QCL source. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the instructions, when executed by the at least one processor, further cause the apparatus at least to perform: using, by the terminal device, a QCL source reference signal (RS) of an indicated TCI state as a QCL source. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the QCL source RS is at least one of a signal synchronization block (SSB) or a channel start information (CSI) RS. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, a TRS is semi-persistent. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, an activation command for the TRS is provided via DCI signaling. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

According to one aspect, there is provided a method comprising: (i) receiving, by a terminal device and from a network device, configuration information for configuring a radio network temporary identifier (RNTI) for monitoring aperiodic tracking reference signal (aTRS) triggering; and/or (ii) configuring the RNTI for monitoring aTRS triggering. One or more features of the method may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the configuration information further comprises configuration information for configuring the terminal device with a specific RNTI for monitoring the aTRS triggering. One or more features of the method may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the specific RNTI is an A-RNTI. One or more features of the method may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the method further comprises: (i) receiving, by the terminal device, a downlink control information (DCI) transmission; (ii) detecting that the DCI was transmitted using an RNTI; and/or (iii) indicating, based on information provided by the DCI, transmission of an aTRS. One or more features of the method may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the detecting is based on a format of the DCI having cyclic redundancy check (CRC) that is scrambled with A-RNTI. One or more features of the method may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the configuration information further comprises configuration information for configuring the terminal device to monitor at least one of: a first DCI format comprising aTRS information or a second DCI format indicating downlink resource allocation. One or more features of the method may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the method further comprises: determining, based on the second DCI format, to reinterpret one or more fields of the DCI to be applicable for aTRS. One or more features of the method may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, one or more fields of the DCI are set to specific values to indicate that the DCI is configured to trigger aTRS. One or more features of the method may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the configuration information further comprises configuration information for configuring the terminal device to monitor for A-RNTI and cell RNTI (C-RNTI) for monitoring the aTRS triggering. One or more features of the method may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the monitoring the aTRS triggering is based on a DCI format indicating TRS triggering. One or more features of the method may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the configuration information further comprises configuration information for configuring the terminal device to monitor the aTRS triggering using one or more dedicated search spaces. One or more features of the method may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the configuration information further comprises configuration information for configuring the terminal device to monitor the aTRS triggering using at least one of A-RNTI or C-RNTI. One or more features of the method may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the method further comprises: (i) detecting a DCI format, transmitted with at least one of A-RNTI or C-RNTI, on the one or more dedicated search spaces; and/or (ii) indicating the aTRS triggering using one or more parameters. One or more features of the method may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the method further comprises: using a most recent triggered aTRS as a quasi co-location (QCL) source for one or more downlink (DL) transmissions. One or more features of the method may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the method further comprises: using, by the terminal device, one or more specific TRS configurations based on a type of RNTI used for transmitting a TRS trigger. One or more features of the method may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the type of RNTI is at least one of A-RNTI or C-RNTI. One or more features of the method may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the method further comprises: using, by the terminal device, one or more first TRS configurations based on the RNTI being C-RNTI. One or more features of the method may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the method further comprises: using, by the terminal device, one or more second TRS configurations based on the RNTI being A-RNTI. One or more features of the method may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the method further comprises: using, by the terminal device, an indicated transmission configuration indicator (TCI) state as a QCL source. One or more features of the method may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the method further comprises: using, by the terminal device, a QCL source reference signal (RS) of an indicated TCI state as a QCL source. One or more features of the method may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the QCL source RS is at least one of a signal synchronization block (SSB) or a channel start information (CSI) RS. One or more features of the method may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, a TRS is semi-persistent. One or more features of the method may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, an activation command for the TRS is provided via DCI signaling. One or more features of the method may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

According to one aspect, there is provided an apparatus comprising: (i) means for receiving, by a terminal device and from a network device, configuration information for configuring a radio network temporary identifier (RNTI) for monitoring aperiodic tracking reference signal (aTRS) triggering; and/or (ii) means for configuring the RNTI for monitoring aTRS triggering. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the configuration information further comprises configuration information for configuring the terminal device with a specific RNTI for monitoring the aTRS triggering. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

According to one aspect, there is provided a non-transitory computer readable medium comprising computer program instructions that, when executed by an apparatus, cause the apparatus at least to perform: (i) receiving, by a terminal device and from a network device, configuration information for configuring a radio network temporary identifier (RNTI) for monitoring aperiodic tracking reference signal (aTRS) triggering; and/or (ii) configuring the RNTI for monitoring aTRS triggering. One or more features of the non-transitory computer readable medium may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the configuration information further comprises configuration information for configuring the terminal device with a specific RNTI for monitoring the aTRS triggering. One or more features of the non-transitory computer readable medium may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

According to one aspect, there is provided an apparatus comprising at least one processor and at least one memory comprising instructions that, when executed by the at least one processor, cause the apparatus at least to perform: transmitting, by a network device and to a terminal device, configuration information for configuring a radio network temporary identifier (RNTI) for monitoring aperiodic tracking reference signal (aTRS) triggering. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the configuration information further comprises configuration information for configuring the terminal device with a specific RNTI for monitoring the aTRS triggering. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the specific RNTI is an A-RNTI. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the instructions, when executed by the at least one processor, further cause the apparatus at least to perform: transmitting, by the network device, a downlink control information (DCI) transmission. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the configuration information further comprises configuration information for configuring the terminal device to monitor at least one of: a first DCI format comprising aTRS information or a second DCI format indicating downlink resource allocation. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the configuration information further comprises configuration information for configuring the terminal device to determine, based on the second DCI format, to reinterpret one or more fields of the DCI to be applicable for aTRS. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, one or more fields of the DCI are set to specific values to indicate that the DCI is configured to trigger aTRS. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the configuration information further comprises configuration information for configuring the terminal device to monitor for A-RNTI and cell RNTI (C-RNTI) for monitoring the aTRS triggering. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the monitoring the aTRS triggering is based on a DCI format indicating TRS triggering. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the configuration information further comprises configuration information for configuring the terminal device to monitor the aTRS triggering using one or more dedicated search spaces. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the configuration information further comprises configuration information for configuring the terminal device to monitor the aTRS triggering using at least one of A-RNTI or C-RNTI. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the configuration information further comprises configuration information for configuring the terminal device to detect a DCI format, transmitted with at least one of A-RNTI or C-RNTI, on the one or more dedicated search spaces indicate the aTRS triggering using one or more parameters. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the configuration information further comprises configuration information for configuring the terminal device to use a most recent triggered aTRS as a quasi co-location (QCL) source for one or more downlink (DL) transmissions. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the configuration information further comprises configuration information for configuring the terminal device to use one or more specific TRS configurations based on a type of RNTI used for transmitting a TRS trigger. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the type of RNTI is at least one of A-RNTI or C-RNTI. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the configuration information further comprises configuration information for configuring the terminal device to use one or more first TRS configurations based on the RNTI being C-RNTI. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the configuration information further comprises configuration information for configuring the terminal device to use one or more second TRS configurations based on the RNTI being A-RNTI. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the configuration information further comprises configuration information for configuring the terminal device to use an indicated transmission configuration indicator (TCI) state as a QCL source. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the configuration information further comprises configuration information for configuring the terminal device to use a QCL source reference signal (RS) of an indicated TCI state as a QCL source. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the QCL source RS is at least one of a signal synchronization block (SSB) or a channel start information (CSI) RS. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, a TRS is semi-persistent. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, an activation command for the TRS is provided via DCI signaling. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

According to one aspect, there is provided an apparatus comprising at least one processor and at least one memory comprising instructions that, when executed by the at least one processor, cause the apparatus at least to perform: receiving, by a terminal device, a downlink control information (DCI) message triggering an aperiodic tracking reference signal (aTRS), wherein the DCI message comprises information indicating a bandwidth (BW) of an aTRS, wherein the aTRS comprises a dynamically variable BW. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the dynamically variable BW of the aTRS is at least partially configured by the DCI message. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the dynamically variable BW is at least partially configured by a radio resource control (RRC) message. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, at least one codepoint of the DCI message indicates at least one of a default BW configured for the aTRS or a first BW configured for the aTRS. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, at least one codepoint of the DCI message indicates a second BW configured for the aTRS. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, at least one codepoint of the DCI message indicates a third BW configured for the aTRS. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, at least one codepoint of the DCI message indicates that a BW configured for the aTRS should be equivalent to a physical downlink shared channel (PDSCH) BW provided by the DCI. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, at least one codepoint of the DCI message indicates one or more BWs by an RRC message. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the DCI message does not schedule a PDSCH transmission and wherein a PDSCH resource allocation field of the DCI message is reconfigured to indicate that the dynamically variable BW of the aTRS should be determined based on a PDSCH resource allocation provided by the DCI message. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, based on the DCI message not configuring the dynamically variable BW, at least one codepoint of the DCI is not interpreted for BW. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the dynamically variable BW is configured by a medium access control (MAC) control element (CE) indication. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the MAC CE indication comprises a field indicating a configuration identifier (ID) of the aTRS and BW codepoint indication. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the configuration information further comprises configuration information for configuring the terminal device with a maximum scheduling BW. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the configuration information further comprises configuration information for configuring a default BW to be adapted based on the maximum scheduling BW. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the maximum scheduling BW is at least one of a downlink (DL) bandwidth part (BWP) BW or a current scheduling BW. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the configuration information further comprises configuration information for configuring one or more time domain properties of the aTRS additionally or alternatively to configuration information for configuring the dynamically variable BW of the aTRS. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the DCI message comprises a field indicating whether either the dynamically variable BW or the one or more time domain properties should be changed or whether both the dynamically variable BW and the one or more time domain properties should be changed. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the DCI message comprises a field indicating that an applied periodicity of a semi-persistent (SP) TRS transmission should be changed. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the DCI message is configured to deactivate the SP TRS transmission. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

According to one aspect, there is provided a method comprising: receiving, by a terminal device, a downlink control information (DCI) message triggering an aperiodic tracking reference signal (aTRS), wherein the DCI message comprises information indicating a bandwidth (BW) of an aTRS, wherein the aTRS comprises a dynamically variable BW. One or more features of the method may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the dynamically variable BW of the aTRS is at least partially configured by the DCI message. One or more features of the method may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the dynamically variable BW is at least partially configured by a radio resource control (RRC) message. One or more features of the method may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, at least one codepoint of the DCI message indicates at least one of a default BW configured for the aTRS or a first BW configured for the aTRS. One or more features of the method may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, at least one codepoint of the DCI message indicates a second BW configured for the aTRS. One or more features of the method may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, at least one codepoint of the DCI message indicates a third BW configured for the aTRS. One or more features of the method may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, at least one codepoint of the DCI message indicates that a BW configured for the aTRS should be equivalent to a physical downlink shared channel (PDSCH) BW provided by the DCI. One or more features of the method may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, at least one codepoint of the DCI message indicates one or more BWs by an RRC message. One or more features of the method may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the DCI message does not schedule a PDSCH transmission and wherein a PDSCH resource allocation field of the DCI message is reconfigured to indicate that the dynamically variable BW of the aTRS should be determined based on a PDSCH resource allocation provided by the DCI message. One or more features of the method may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, based on the DCI message not configuring the dynamically variable BW, at least one codepoint of the DCI is not interpreted for BW. One or more features of the method may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the dynamically variable BW is configured by a medium access control (MAC) control element (CE) indication. One or more features of the method may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the MAC CE indication comprises a field indicating a configuration identifier (ID) of the aTRS and BW codepoint indication. One or more features of the method may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the configuration information further comprises configuration information for configuring the terminal device with a maximum scheduling BW. One or more features of the method may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the configuration information further comprises configuration information for configuring a default BW to be adapted based on the maximum scheduling BW. One or more features of the method may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the maximum scheduling BW is at least one of a downlink (DL) bandwidth part (BWP) BW or a current scheduling BW. One or more features of the method may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the configuration information further comprises configuration information for configuring one or more time domain properties of the aTRS additionally or alternatively to configuration information for configuring the dynamically variable BW of the aTRS. One or more features of the method may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the DCI message comprises a field indicating whether either the dynamically variable BW or the one or more time domain properties should be changed or whether both the dynamically variable BW and the one or more time domain properties should be changed. One or more features of the method may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the DCI message comprises a field indicating that an applied periodicity of a semi-persistent (SP) TRS transmission should be changed. One or more features of the method may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the DCI message is configured to deactivate the SP TRS transmission. One or more features of the method may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

According to one aspect, there is provided an apparatus comprising: means for receiving, by a terminal device, a downlink control information (DCI) message triggering an aperiodic tracking reference signal (aTRS), wherein the DCI message comprises information indicating a bandwidth (BW) of an aTRS, wherein the aTRS comprises a dynamically variable BW. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the dynamically variable BW of the aTRS is at least partially configured by the DCI message. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the dynamically variable BW is at least partially configured by a radio resource control (RRC) message. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, at least one codepoint of the DCI message indicates at least one of a default BW configured for the aTRS or a first BW configured for the aTRS. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, at least one codepoint of the DCI message indicates a second BW configured for the aTRS. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, at least one codepoint of the DCI message indicates a third BW configured for the aTRS. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, at least one codepoint of the DCI message indicates that a BW configured for the aTRS should be equivalent to a physical downlink shared channel (PDSCH) BW provided by the DCI. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, at least one codepoint of the DCI message indicates one or more BWs by an RRC message. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the DCI message does not schedule a PDSCH transmission and wherein a PDSCH resource allocation field of the DCI message is reconfigured to indicate that the dynamically variable BW of the aTRS should be determined based on a PDSCH resource allocation provided by the DCI message. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, based on the DCI message not configuring the dynamically variable BW, at least one codepoint of the DCI is not interpreted for BW. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the dynamically variable BW is configured by a medium access control (MAC) control element (CE) indication. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the MAC CE indication comprises a field indicating a configuration identifier (ID) of the aTRS and BW codepoint indication. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the configuration information further comprises configuration information for configuring the terminal device with a maximum scheduling BW. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the configuration information further comprises configuration information for configuring a default BW to be adapted based on the maximum scheduling BW. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the maximum scheduling BW is at least one of a downlink (DL) bandwidth part (BWP) BW or a current scheduling BW. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the configuration information further comprises configuration information for configuring one or more time domain properties of the aTRS additionally or alternatively to configuration information for configuring the dynamically variable BW of the aTRS. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the DCI message comprises a field indicating whether either the dynamically variable BW or the one or more time domain properties should be changed or whether both the dynamically variable BW and the one or more time domain properties should be changed. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the DCI message comprises a field indicating that an applied periodicity of a semi-persistent (SP) TRS transmission should be changed. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the DCI message is configured to deactivate the SP TRS transmission. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

According to one aspect, there is provided a non-transitory computer readable medium comprising computer program instructions that, when executed by an apparatus, cause the apparatus at least to perform: receiving, by a terminal device, a downlink control information (DCI) message triggering an aperiodic tracking reference signal (aTRS), wherein the DCI message comprises information indicating a bandwidth (BW) of an aTRS, wherein the aTRS comprises a dynamically variable BW. One or more features of the non-transitory computer readable medium may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the dynamically variable BW of the aTRS is at least partially configured by the DCI message. One or more features of the non-transitory computer readable medium may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the dynamically variable BW is at least partially configured by a radio resource control (RRC) message. One or more features of the non-transitory computer readable medium may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

According to one aspect, there is provided an apparatus comprising at least one processor and at least one memory comprising instructions that, when executed by the at least one processor, cause the apparatus at least to perform: transmitting, by a network device and to a terminal device, a downlink control information (DCI) message triggering an aperiodic tracking reference signal (aTRS), wherein the DCI message comprises information indicating a bandwidth (BW) of an aTRS, wherein the aTRS comprises a dynamically variable BW. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the dynamically variable BW of the aTRS is at least partially configured by the DCI message. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the dynamically variable BW is at least partially configured by a radio resource control (RRC) message. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

According to one aspect, there is provided a method comprising: transmitting, by a network device and to a terminal device, a downlink control information (DCI) message triggering an aperiodic tracking reference signal (aTRS), wherein the DCI message comprises information indicating a bandwidth (BW) of an aTRS, wherein the aTRS comprises a dynamically variable BW. One or more features of the method may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the dynamically variable BW of the aTRS is at least partially configured by the DCI message. One or more features of the method may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the dynamically variable BW is at least partially configured by a radio resource control (RRC) message. One or more features of the method may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

According to one aspect, there is provided an apparatus comprising: means for transmitting, by a network device and to a terminal device, a downlink control information (DCI) message triggering an aperiodic tracking reference signal (aTRS), wherein the DCI message comprises information indicating a bandwidth (BW) of an aTRS, wherein the aTRS comprises a dynamically variable BW. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the dynamically variable BW of the aTRS is at least partially configured by the DCI message. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the dynamically variable BW is at least partially configured by a radio resource control (RRC) message. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

According to one aspect, there is provided a non-transitory computer readable medium comprising computer program instructions that, when executed by an apparatus, cause the apparatus at least to perform: transmitting, by a network device and to a terminal device, a downlink control information (DCI) message triggering an aperiodic tracking reference signal (aTRS), wherein the DCI message comprises information indicating a bandwidth (BW) of an aTRS, wherein the aTRS comprises a dynamically variable BW. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the dynamically variable BW of the aTRS is at least partially configured by the DCI message. One or more features of the non-transitory computer readable medium may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the dynamically variable BW is at least partially configured by a radio resource control (RRC) message. One or more features of the non-transitory computer readable medium may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

According to one aspect, there is provided an apparatus comprising at least one processor and at least one memory comprising instructions that, when executed by the at least one processor, cause the apparatus at least to perform: (i) receiving, by a terminal device and from a network device, a downlink control information (DCI) message triggering a semi-persistent tracking reference signal (spTRS); (ii) receiving, by the terminal device, information comprising one or more adaptation indications for the spTRS, wherein the one or more adaptation indications comprise at least one of bandwidth (BW) indications or periodicity indications; (iii) changing, based on the one or more adaptation indications, at least one of the BW or the periodicity; and/or (iv) tracking, based on a reduction of periodicity or an increase in BW, at least one of time or frequency of a channel. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the instructions, when executed by the at least one processor, further cause the apparatus at least to perform: indicating, by the terminal device and prior to the changing, an increased modulation and coding scheme (MCS) based on one or more conditions of the channel. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the apparatus is a terminal device. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

According to one aspect, there is provided a method comprising: (i) receiving, by a terminal device and from a network device, a downlink control information (DCI) message triggering a semi-persistent tracking reference signal (spTRS); (ii) receiving, by the terminal device, information comprising one or more adaptation indications for the spTRS, wherein the one or more adaptation indications comprise at least one of bandwidth (BW) indications or periodicity indications; (iii) changing, based on the one or more adaptation indications, at least one of the BW or the periodicity; and/or (iv) tracking, based on a reduction of periodicity or an increase in BW, at least one of time or frequency of a channel. One or more features of the method may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the method further comprises: indicating, by the terminal device and prior to the changing, an increased modulation and coding scheme (MCS) based on one or more conditions of the channel. One or more features of the method may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, an apparatus implementing the method is a terminal device. One or more features of the method may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

According to one aspect, there is provided an apparatus comprising: (i) means for receiving, by a terminal device and from a network device, a downlink control information (DCI) message triggering a semi-persistent tracking reference signal (spTRS); (ii) means for receiving, by the terminal device, information comprising one or more adaptation indications for the spTRS, wherein the one or more adaptation indications comprise at least one of bandwidth (BW) indications or periodicity indications; (iii) means for changing, based on the one or more adaptation indications, at least one of the BW or the periodicity; and/or (iv) means for tracking, based on a reduction of periodicity or an increase in BW, at least one of time or frequency of a channel. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the apparatus further comprises: means for indicating, by the terminal device and prior to the changing, an increased modulation and coding scheme (MCS) based on one or more conditions of the channel. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the apparatus is a terminal device. One or more features of the apparatus may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

According to one aspect, there is provided a non-transitory computer readable medium comprising computer program instructions that, when executed by an apparatus, cause the apparatus at least to perform: (i) receiving, by a terminal device and from a network device, a downlink control information (DCI) message triggering a semi-persistent tracking reference signal (spTRS); (ii) receiving, by the terminal device, information comprising one or more adaptation indications for the spTRS, wherein the one or more adaptation indications comprise at least one of bandwidth (BW) indications or periodicity indications; (iii) changing, based on the one or more adaptation indications, at least one of the BW or the periodicity; and/or (iv) tracking, based on a reduction of periodicity or an increase in BW, at least one of time or frequency of a channel. One or more features of the non-transitory computer readable medium may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the computer program instructions, when executed by the apparatus, further cause the apparatus at least to perform: indicating, by the terminal device and prior to the changing, an increased modulation and coding scheme (MCS) based on one or more conditions of the channel. One or more features of the non-transitory computer readable medium may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

In some embodiments, the apparatus is a terminal device. One or more features of the non-transitory computer readable medium may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

### LIST OF THE DRAWINGS

In the following, certain embodiments will be described in greater detail with reference to the accompanying drawings, in which:

FIG. 1 shows an example of a communication network to which examples disclosed herein may be applied;

FIG. 2 shows an example of TRS configuration options;

FIG. 3 shows an example of various QCL chains;

FIG. 4 shows an example of a transmission configuration indicator (TCI) framework;

FIG. 5 shows an example of a signal diagram in accordance with a further example embodiment;

FIG. 6 shows an example of a method in accordance with a further example embodiment; and

FIG. 7 shows an example of an apparatus that may be configured in accordance with an example embodiment.

### DETAILED DESCRIPTION

The following embodiments are exemplary. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments. Further, when a particular feature, structure, or characteristic is described in connection of an embodiment, it is within the knowledge of one skilled in the art to apply such feature, structure, or characteristic in connection with other embodiments whether or not explicitly described. It shall be understood that although the terms “first”, “second”, and/or the like may be used herein to describe various elements, these elements should not be limited by these terms. These terms are only used to distinguish one element from another.

For the purposes of the present disclosure, the phrases “at least one of A or B”, “at least one of A and B”, and “A and/or B” mean (A), (B), or (A and B). For the purposes of the present disclosure, the phrase “A, B, and/or C” means (A), (B), (C), (A and B), (A and C), (B and C), or (A, B, and C).

Certain embodiments described may be implemented in a communication network, such as any of the following radio access technologies (RATs): Worldwide Interoperability for Micro-wave Access (WiMAX), Global System for Mobile communications (GSM, 2G), GSM EDGE radio access Network (GERAN), General Packet Radio Service (GRPS), Universal Mobile Telecommunication System (UMTS, 3G) based on basic wideband-code division multiple access (W-CDMA), high-speed packet access (HSPA), Long Term Evolution (LTE), LTE-Advanced, and enhanced LTE (eLTE), 5G (also called NR), or any future RAT such as 6G. Moreover, communications within the communication network may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), and/or Discrete Fourier Transform spread OFDM (DFT-s-OFDM).

As used herein, the term “network device” or “network node” refers to a node in a communication network via which user equipment may access the network and/or which is capable of controlling radio communication and managing radio resources within a cell. The network node or network device may be referred to as a base station (BS), an access point (AP), or an access node. The network device may be, depending on the applied technology, for example, a node B (NodeB or NB), an evolved NodeB (eNodeB or eNB), an NR NB (also referred to as a gNB), a Remote Radio Unit (RRU), a radio head (RH), a remote radio head (RRH), a relay, an Integrated Access and Backhaul (IAB) node, a low power node, a non-terrestrial network (NTN) or non-ground network device such as a satellite network device, a low earth orbit (LEO) satellite and a geosynchronous earth orbit (GEO) satellite, or an aircraft network device.

Moreover, in connection of split radio access network (RAN), the network device may refer to a centralized unit (CU) or a base station and/or a distributed unit (DU) of a base station. An interface between CU and DU may be referred to as an F1 interface in NR. In the split RAN architecture, node operations may be carried out, at least partly, in the central/centralized unit, CU (e.g., server, host, or node) operationally coupled to the DU, (e.g., a radio head/node). One CU may control one or more DUs, acting at least as transmit/receive (Tx/Rx) nodes. In some embodiments, the DUs may comprise, for example, a radio link control (RLC), medium access control (MAC) layer and a physical (PHY) layer, whereas the CU may comprise the layers above the RLC layer, such as a packet data convergence protocol (PDCP) layer, a radio resource control (RRC) and an internet protocol (IP) layers. Other functional splits are also possible. In practice, any processing task may be performed in either the CU or the DU and the boundary where the responsibility is shifted between the CU and the DU may depend on the applied implementation.

The term “terminal device” refers to any end device that may be capable of wireless communication. By way of example, a terminal device may be referred to as a communication device, user equipment (UE), a Subscriber Station (SS), or a Mobile Station (MS). The terminal device may include a mobile phone, a cellular phone, a smart phone, voice over IP (VoIP) phones, wireless local loop phones, a tablet, a wearable terminal device, a personal digital assistant (PDA), portable computers, desktop computers, image capture terminal devices such as digital cameras, gaming terminal devices, music storage and playback appliances, vehicle-mounted wireless terminal devices, USB dongles, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain context), a consumer electronics device, a device operating on commercial and/or industrial networks, and/or the like.

A term “resource”, as used herein, may refer to radio resources in time domain, in frequency domain, in space domain, and/or in code domain. Some examples of resources include, for example, physical resource block (PRB), a radio frame, a subframe, a time slot, a sub-band, a frequency region, a sub-carrier, a beam, and/or the like. The term “transmission” and/or “reception” may refer to wirelessly transmitting and/or receiving via a wireless propagation channel on radio resources.

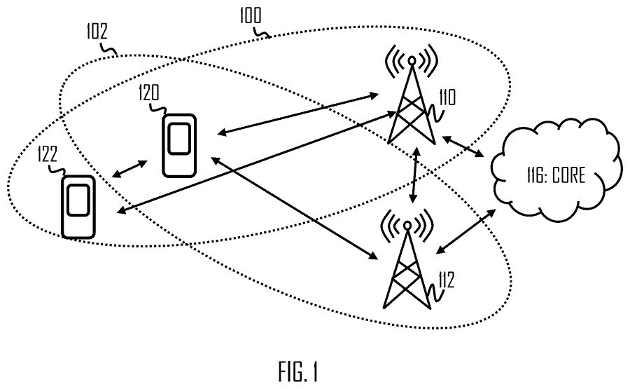

FIG. 1 illustrates an example of a communication network to which examples disclosed herein may be applied. The communication network or a cellular communication network may comprise a network node 110 providing one or more cells, such as cell 100, and a network node 112 providing one or more other cells, such as cell 102. Each cell may be, for example, a macro cell, a micro cell, a femto cell, or a pico cell, for example. The cell may define a coverage area or a service area of the corresponding access node.

The network node 110 may provide a user equipment (UE) 120 (one or more UEs) with wireless access to the communication network. The wireless access may comprise downlink (DL) communication from the network node to the UE 120 and uplink (UL) communication from the UE 120 to the network node. Examples of uplink channels comprise physical uplink control channel (PUCCH) for transmitting control information and physical uplink shared channel (PUSCH) for transmitting data towards the network. Examples of downlink channels comprise physical downlink control channel (PDCCH) for transmitting control information and physical downlink shared channel (PDSCH) for transmitting data towards the user equipment.

There may be a plurality of UEs 120, 122, in the system. Each of them may be served by the same of by different network nodes 110, 112. UE may be configured with dual connectivity (DC), wherein the UE, for example, UE 120, may be connected to multiple network nodes 110, 112. The UEs 120, 122, may communicate with each other, in case device-to-device (D2D) communication interface is established between them via a so-called sidelink (SL). Such D2D communications may be referred to as machine-to-machine, peer-to-peer (P2P) communications, or vehicle-to-vehicle (V2V), for example.

In the case of multiple network nodes in the communication network, the network nodes may be connected to each other via an interface. LTE specifications call such an interface an X2 interface. An interface between an LTE node and a 5G node, or between two 5G nodes, may be called an Xn interface.

The network nodes 110 and 112 may be further connected via another interface to a core network 116 of the communication network. The LTE specifications specify the core network as an evolved packet core (EPC), and the core network may comprise, for example, a mobility management entity (MME) and a gateway node. The MME may handle mobility of terminal devices in a tracking area encompassing a plurality of cells and handle signaling connections between the terminal devices and the core network. The gateway node may handle data routing in the core network and to/from the terminal devices. The 5G specifications specify the core network as a 5G core (5GC). The 5G core may comprise, for example, an access and mobility management function (AMF) and a use plane function/gateway (UPF) and other functions. The AMF may handle termination of non-access stratum (NAS) signaling, NAS ciphering and integrity protection, registration management, connection management, mobility management, access authentication and authorization, security context management, and/or the like. The UPF node may support packet routing and forwarding, packet inspection, and quality of service (QoS) handling, for example.

Various embodiments of the present disclosure are generally related to physical layer design in some technologies, for example, such as in 6G technologies. Advantages of the present disclosure may include enhancing PDSCH reception performance, for example, in 6G technologies.

In at least some technologies (e.g., 5G technologies, 6G technologies, and/or other technologies), TRSs may be configured to assist terminal devices in channel estimation, for example, for reception of downlink (DL) signals and/or channels (e.g., PDCCH, PDSCH, and/or the like). The TRSs may be periodic TRSs. TRSs may be variants of channel state indicator (CSI) reference signals (RSs). In at least some technologies, a periodic TRS may be configured for a respective terminal device of one or more terminal devices. The respective terminal device may perform, based on the TRS, time and/or frequency synchronization tracking, long term doppler shift, doppler spread, delay spread, average delay estimation, and/or other operations. The periodic TRS may be transmitted using a cell-specific signal synchronization block (SSB) beam.

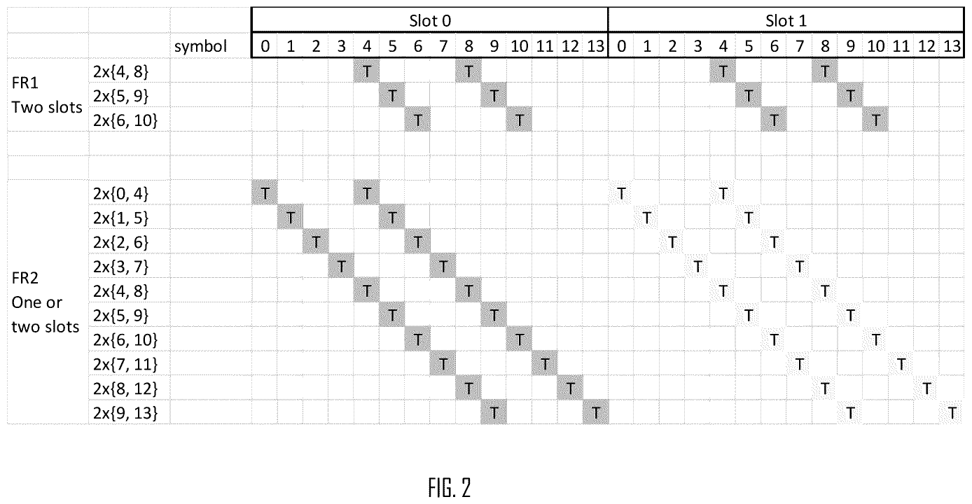

Referring now to FIG. 2, an example of TRS configuration options is shown, for example, for 5G technologies, 6G technologies, and/or other technologies. In the example of FIG. 2, there are several frequency bands for transmissions, for example, such as frequency range 1 (FR1), which includes frequencies below 6 GHz, and frequency range 2 (FR2), which includes frequencies greater than or equal to 6 GHz. In 5G technologies, TRSs may be configured as one-port CSI-RS resources with various parameters, for example, including at least:
a. TRS burst length is two consecutive valid downlink slots in FR1 and one or two consecutive valid downlink slots in FR2;
b. Respective TRS slots comprise two TRS symbols;
c. TRS symbols in the respective TRS slots have four symbol separation;
d. TRS burst periodicity is 10 ms, 20 ms, 40 ms, 80 ms, and/or another value; and/or
e. other parameters.

In at least some technologies, for example, such as 5G technologies. TRSs are periodic and UE-specific. For example, TRSs are configured separately for respective UEs. In some examples, an aTRS is associated with a periodic TRS, and the aTRS uses the QCL source of the periodic TRS as its QCL source.

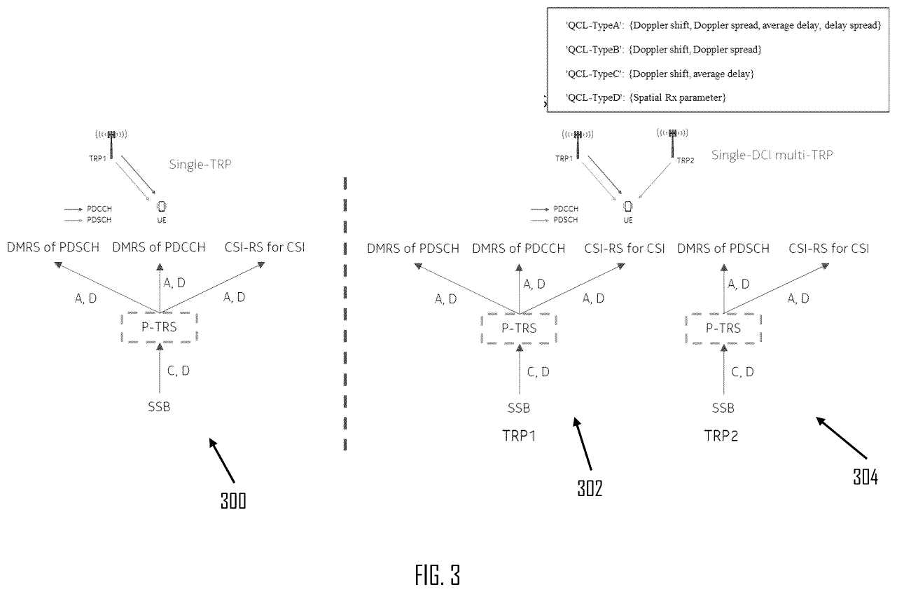

Referring now to FIG. 3, an example of various QCL chains is shown, for example, for providing terminal device RSs to estimate various channel parameters. The various QCL chains include QCL chain 300, QCL chain 302, and QCL chain 304. Progression along the various QCL chains may rely on hierarchical beam domain operation (e.g., wide to narrow). The example of FIG. 3 shows QCL chains for reception of DL signals and/or channels, for example, such as PDCCHs, PDSCHs, CSI-RSs, and/or other signals and/or channels. In the QCL chains of FIG. 3, periodic TRS (and/or periodic SSB) is the basis of the various QCL chains. In the example of FIG. 3, the SSB is a synchronization and/or physical broadcast channel (PBCH) block. For example, the SSB comprises primary synchronization signals, secondary synchronization signals, PBCHs, and/or demodulation reference signals (DMRSs). In some examples, the default periodicity for SSB is 20 ms.

In some examples, one or more of the various QCL schemes can be used individually or in combination, for example, including at least:
a. a first QCL scheme (e.g., QCL-TypeA) for updating doppler shift, doppler spread, average delay, and delay spread;
b. a second QCL scheme (e.g., QCL-TypeB) for updating doppler shift and doppler spread;
c. a third QCL scheme (e.g., QCL-TypeC) for updating doppler shift and average delay;

### D. a fourth QCL scheme (e.g., QCL-typed) for updating a spatial reception (Rx) parameter; and/or

e. other QCL schemes.

Referring now to QCL chain 300, a single transmission and reception point (TRP) example is shown. The single TRP TRP1 transmits PDCCH transmission(s) and PDSCH transmission(s) to a UE. QCL chain 300 shows the third QCL scheme and the fourth QCL scheme being used between the SSB (e.g., periodic SSB) and the periodic TRS (labeled in FIG. 3 as “P-TRS”). In QCL chain 300, the first QCL scheme and the fourth QCL scheme are used between the P-TRS and the DMRS of the PDSCH. In QCL chain 300, the first QCL scheme and the fourth QCL scheme are used between the P-TRS and the DMRS of the PDCCH. In QCL chain 300, the first QCL scheme and the fourth QCL scheme are used between the P-TRS and the CSI-RS for the CSI. In some embodiments, the RS providing the QCL assumption (e.g., the first QCL scheme QCL-typeA) for another RS (e.g., QCL target RS) may be referred to as a QCL source.

Referring now to QCL chain 302 and QCL chain 304, a multi-TRP and single downlink control information (DCI) example is shown. A first TRP TRP1 transmits PDCCH transmission(s) and PDSCH transmission(s) to a UE. A second TRP TRP2 transmits PDSCH transmission(s) to the UE. QCL chain 302 is associated with the TRP1 transmissions and QCL chain 304 is associated with the TRP2 transmissions. In QCL chain 302, the third QCL scheme and the fourth QCL scheme are used between the SSB and the P-TRS. In QCL chain 302, the first QCL scheme and the fourth QCL scheme are used between the P-TRS and the DMRS of the PDSCH. In QCL chain 302, the first QCL scheme and the fourth QCL scheme are used between the P-TRS and the DMRS of the PDCCH. In QCL chain 302, the first QCL scheme and the fourth QCL scheme are used between the P-TRS and the CSI-RS for the CSI. In QCL chain 304, the third QCL scheme and the fourth QCL scheme are used between the SSB and the P-TRS. In QCL chain 304, the first QCL scheme and the fourth QCL scheme are used between the P-TRS and the DMRS of the PDSCH. In QCL chain 304, the first QCL scheme and the fourth QCL scheme are used between the P-TRS and the CSI-RS for the CSI.

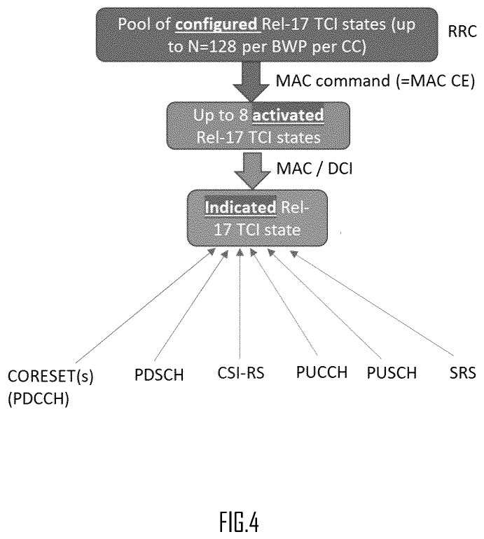

Referring now to FIG. 4, an example of a transmission configuration indicator (TCI) framework, for example, for 5G technologies, 6G technologies, and/or other technologies is shown. The TCI framework may be a unified TCI framework. The TCI framework is a framework for DL and uplink (UL) beam indication.

In the example of FIG. 4, RRC configures a set of joint DL and UL TCI states and/or separate DL TCI states and separate UL TCI states. A MAC control element (CE) activates up to N joint TCI states (e.g., up to 8 joint TCI states) and/or N separate TCI states (e.g., up to 8 separate TCI states). The MAC and/or TCI in PDCCH indicates one of the activated TCI states to be the indicated TCI state, wherein the indicated TCI state is used for channel transmission. Before a first DCI indication (e.g., the MAC and/or TCI in the PDCCH), the UE uses the first activated TCI state as an indicated TCI state. Signals and/or channels for which the unified TCI framework of FIG. 4 is applicable include at least: control resources set(s) (CORESET(s)), PDSCH(s), CSI-RS(s), PUCCH(s), PUSCH(s), sounding reference signal(s) (SRS(s)), and/or others. At least some (e.g. up to all) of the signals and/or channels use the indicated TCI state according to the RRC configuration.

Configured TCI states for joint DL and UL TCI state update is up to 128 configured TCI states per bandwidth part (BWP) per CC. In the case of a UE being configured with separate DL TCI states and UL TCI states, the quantity of configured TCI states relies on UE capability such that candidate values for the DL TCI states are 64 and 128 and candidate values for the UL TCI states is 32 and 64.

In the example of FIG. 4, “Rel-17” (short for 3GPP Release 17) is used to indicate a configuration of TCI states according to Rel-17 by way of example only and is not intended to be limiting. For example, TCI states configured according to any other agreement, specification, and/or the like may be used in the example of FIG. 4.

In some embodiments, for example, such as those using 6G technologies and/or other technologies (e.g., future technologies), TRS-type RS transmission may be relied upon. In some embodiments, advantages of TRS may include enabling higher peak rates (e.g., providing large gains for enabling higher order modulations, for example, beyond 16 QAM).

At least one problem with conventional solutions is that terminal devices rely on configurations of periodic TRSs for use as QCL sources. In at least some conventional solutions, an aTRS is associated with a periodic TRS; for example, the aTRS is not transmitted without the associated periodic TRS.

Various embodiments of the present disclosure may provide for advantages such as increased network energy efficiency based on configuring system design to: operate using aTRS and/or eliminate periodical terminal-device-specific tracking signals.

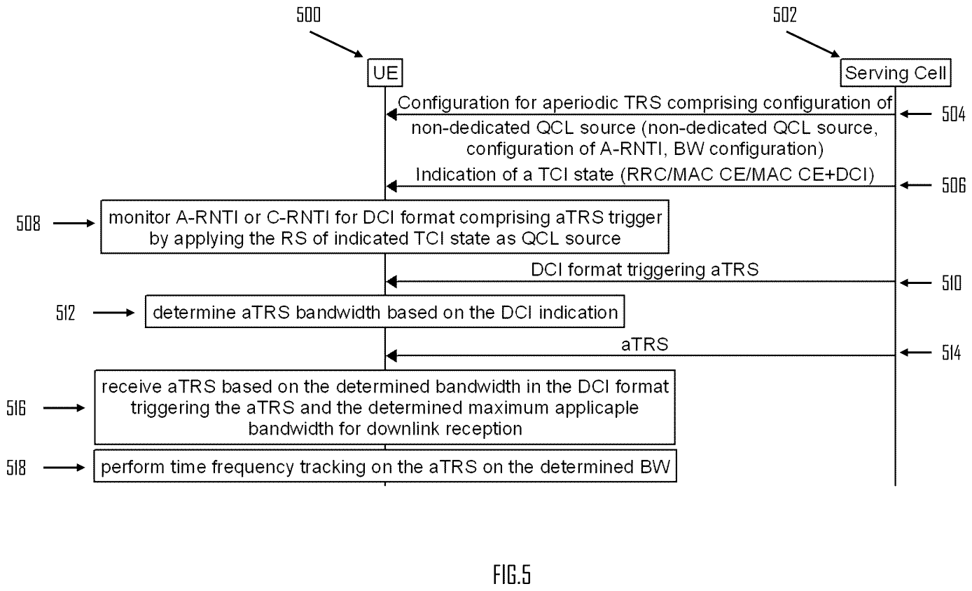

Referring now to FIG. 5, an example of a signal diagram is shown. The signal diagram shows communications between a terminal labeled “device UE 500” and a network device labeled “serving cell 502”. At step/operation 504, the serving cell 502 may transmit to the UE 500 configuration information for aTRS comprising configuration information for configuring a non-dedicated QCL source (e.g., for configuring a non-dedicated QCL source, for configuring aperiodic radio network temporary identifiers (A-RNTIs), for configuring bandwidths (BWs), and/or the like). At step/operation 506, the serving cell 502 may transmit to the UE 500 information (e.g., RRC, MAC CE, a combination of MAC CE and DCI, and/or the like) indicating at least one TCI state. At step/operation 508, the UE 500 may monitor A-RNTI(s) and/or cell RNTIs (C-RNTI(s)) for at least one DCI format comprising at least one aTRS trigger. For example, the UE 500 may monitor the A-RNTI(s) and/or the C-RNTI(s) by applying an RS of an indicated TCI state as a QCL source. At step/operation 510, the serving cell 502 may transmit to the UE 500 the at least one DCI format triggering the aTRS. At step/operation 512, the UE 500 may determine BW of the aTRS based on the DCI indication. At step/operation 514, the serving cell 502 may transmit to the UE 500 the aTRS (and/or additional aTRSs). At step/operation 516, the UE 500 may receive the aTRS based on the determined BW in the DCI format triggering the aTRS and/or based on the determined maximum applicable BW for DL reception. At step/operation 518, the UE 500 may perform time and/or frequency tracking on the aTRS on the determined BW.

In some embodiments, a TRS may be a semi-persistent TRS (spTRS). In some embodiments, the spTRS may be transmitted for a specific time duration and with a specific periodicity. For example, the spTRS may be at least sometimes transmitted periodically and at least sometimes transmitted aperiodically. In some embodiments, the spTRS may be configured, based on configuration information, to be triggered using DL control signaling, for example, such as DCI, MAC CE, and/or the like.

In any embodiments of the present disclosure, spTRS may be used interchangeably with aTRS (e.g., any features, embodiments, examples, and/or the like pertaining to aTRS may be implemented for spTRS).

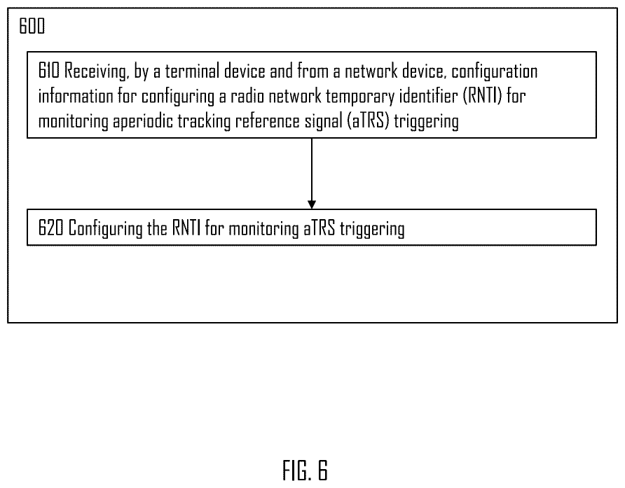

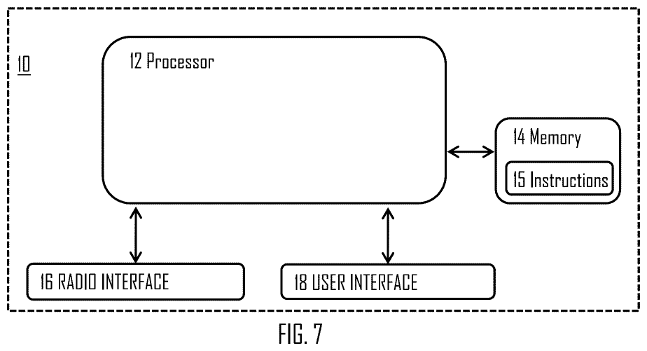

Referring now to FIG. 6, an example of a method 600 is shown. At operation 610, a terminal device may include means, such as at least one processor 12, the radio interface 16 or the like of the apparatus 10 of FIG. 7, for receiving, from a network device, configuration information for configuring a radio network temporary identifier (RNTI) for monitoring aperiodic tracking reference signal (aTRS) triggering. At operation 620, the apparatus includes means, such as the at least one processor or the like, for configuring the RNTI to monitor aTRS triggering. The method 600 may further comprise one or more additional operations. The one or more operations may be based, at least in part, on the descriptions herein.

Referring now to FIG. 6, an example of a method 600 is shown. At step/operation 610, a terminal device may receive, from a network device, configuration information for configuring a radio network temporary identifier (RNTI) for monitoring aperiodic tracking reference signal (aTRS) triggering. At step/operation 620, the RNTI may be configured for monitoring aTRS triggering. The method 600 may further comprise one or more additional steps/operations. The one or more steps/operations may be based, at least in part, on the descriptions herein.

FIG. 7 shows, by way of example, a block diagram of an apparatus 10. The apparatus 10 comprises, for example, at least one processor 12 and at least one memory 14 storing instructions 15 that, when executed by the at least one processor 12, cause the apparatus 10 at least to perform the method or methods as disclosed herein, and any of the embodiments thereof. In an example, the at least one memory 14 and instructions 15 (e.g., a computer program, code, software, and/or the like) are configured, with the at least one processor 12, to cause the apparatus 10 to perform the method or methods as disclosed herein, such as in relation to FIGS. 6-8, and any of the embodiments thereof.

A processor 12 may comprise circuitry, or be constituted as circuitry or circuitries, the circuitry or circuitries being configured to perform phases of methods in accordance with certain example embodiments described herein. As used in this application, the term “circuitry” may refer to one or more or all of the following: (a) hardware-only circuit implementations, such as implementations in only analog and/or digital circuitry, and (b) combinations of hardware circuits and software, such as, as applicable: (i) a combination of analog and/or digital hardware circuit(s) with software/firmware and (ii) any portions of hardware processor(s) with software (including digital signal processor(s)), software, and memory(ies) that work together to cause an apparatus, such as a user equipment, to perform various functions), and (c) hardware circuit(s) and/or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The memory 14 may be implemented using any suitable data storage technology. The memory may comprise a database for storing data. The memory 14 may be at least in part external to apparatus 10 but accessible to apparatus 10.

The instructions 15 may be comprised in a computer-readable medium or a non-transitory computer readable medium. A term “non-transitory”, as used herein, is a limitation of the medium itself (e.g., tangible, not a signal) as opposed to a limitation on data storage persistency (e.g., random access memory (RAM) vs. read only memory (ROM)).

For example, the apparatus 10 is a terminal device, such as the UE of FIGS. 1 and/or 6. As another example, the apparatus is comprised in such a terminal device, for example, as a chipset configured to control the terminal device. The apparatus 10 may be caused or configured to perform at least the method of FIG. 6 and/or any one or more of the embodiments described.

As another example, the apparatus 10 is a network node, for example, the network node of FIG. 1. In another embodiment, the apparatus is comprised in such a network node, for example, as a chipset configured to control the network node. The apparatus 10 may be caused or configured to perform at least the method of FIG. 6 and/or any one or more of the embodiments described herein.

The apparatus may comprise one or more entities of any protocol layers, such as a MAC entity, an RRC entity, an RLC entity, a PDCP entity, a PHY entity, and/or the like. In some embodiments, the entity is configured to perform at least the method of FIG. 6 and/or any one or more of the embodiments described.

The apparatus 10 comprises a radio interface 16. The radio interface 16 may provide the apparatus 10 with communication capabilities. The radio interface 16 may comprise a receiver configured to receive information in accordance with at least one cellular or non-cellular standard. The radio interface 16 may comprise a transmitter configured to transmit information in accordance with at least one cellular or non-cellular standard. The receiver may comprise more than one receiver. The transmitter may comprise more than one transmitter. The radio interface 16 may comprise a transceiver configured to receive and transmit information in accordance with at least one cellular or non-cellular standard. The transceiver may comprise more than one transceiver.

The apparatus 10 may comprise a user interface 18 comprising, for example, at least one of a keypad, a microphone, a touch display, a display, a speaker, and/or the like. The user interface 18 may be used to control the apparatus by a user. The user interface 18 may be external to the apparatus 10. For example, the apparatus 10 may be connected to another device, such as a computer, either via wireless or wired connection, and the apparatus 10 is controlled by the user via the computer.

In an embodiment, at least some of the processes described herein may be carried out by an apparatus comprising means for carrying out at least some of the described processes. Means for performing the method as disclosed herein may include software and/or hardware components of the apparatus 10. For example, the at least one processor 12, the memory 14, and the instructions 15 (e.g., computer program code) form means for carrying out the method or methods as disclosed herein, and any of the embodiments thereof. As used herein, the term “means” is to construed in singular form, e.g., referring to a single element, or in plural form, e.g., referring to a combination of single elements. Therefore, terminology “means for [performing A, B, C]” is to be interpreted to cover an apparatus in which there is only one means for performing A, B, and C, or where there are separate means for performing A, B, and C, or partially or fully overlapping means for performing A, B, C. Further, terminology “means for performing A, means for performing B, means for performing C” is to be interpreted to cover an apparatus in which there is only one means for performing A, B, and C, or where there are separate means for performing A, B, and C, or partially or fully overlapping means for performing A, B, C.

Various embodiments of the present disclosure comprise one or more of the features described herein.

In some embodiments, at least one RNTI may be configured for monitoring aTRS. In some embodiments, a terminal device may be configured with specific RNTI (e.g., A-RNTI) for monitoring an aTRS trigger. In some embodiments, the terminal device may determine, based on detecting a DCI format transmitted using RNTI (e.g., a DCI format with cyclic redundancy check (CRC) scrambled with A-RNTI), using information provided by the DCI to indicate transmission of the aTRS. In some embodiments, the terminal device may be configured to monitor for at least one DCI format that comprises aTRS information. In some embodiments, the terminal device may be configured to monitor for at least one DCI format providing DL resource allocation. For example, the terminal device may determine to reinterpret one or more fields of the at least one DCI to be applicable for aTRS. For example, the one or more fields of the at least one DCI may be set to specific values (e.g., set to all zeros) to indicate that the DCI is for triggering aTRS. In some embodiments, the terminal device may use a specific RNTI (e.g., A-RNTI) for monitoring the aTRS trigger. In some embodiments, the terminal device may be configured to monitor A-RNTI and/or C-RNTI for monitoring the aTRS trigger (e.g., DCI format indicating TRS trigger). In some embodiments, the terminal device may be configured to monitor the aTRS trigger using one or more dedicated search spaces (e.g., using A-RNTI, C-RNTI, and/or the like). For example, the terminal device may detect at least one DCI format transmitted with A-RNTI and/or C-RNTI on the one or more dedicated search spaces, wherein the at least one DCI format indicates the triggering of aTRS with one or more parameters.

In some embodiments, a terminal device uses a most recent triggered aTRS as a QCL source for one or more DL transmissions.

In some embodiments, the type of RNTI used for transmitting a TRS trigger may indicate the use of one or more specific TRS configurations. For example, if C-RNTI is used and/or a DCI indicates TRS triggering, an aTRS indication may indicate a first TRS configuration or a plurality of first TRS configurations. For example, if A-RNTI is used and/or a DCI indicates TRS triggering, an aTRS indication may indicate a second TRS configuration or a plurality of second TRS configurations.

In some examples, the QCL source for a TRS may be determined based on the triggering mechanism which is used. For example, if C-RNTI is used, the QCL source may be an indicated TCI state. For example, if A-RNTI is used, the QCL source may be a QCL source RS of an indicated TCI state, wherein the QCL source RS may be an SSB and/or a CSI-RS.

In some embodiments, the PDCCH DMRS (e.g., of the PDCCH that schedules the DCI triggering the aTRS) may be used as a QCL source. For example, if the terminal device is configured with aTRS having a non-dedicated QCL source, the QCL source for the aTRS may be indicated by the DCI which triggers the transmission of the aTRS.

In some embodiments, if the terminal device is configured with aTRS having a non-dedicated QCL source, an adaptive QCL source, and/or a floating QCL source, the QCL source for the aTRS may be derived based on RS included in the indicated TCI State. As used herein, “non-dedicated” may mean that the QCL source can be changed by indication.

In some embodiments, the QCL source for the aTRS may be CSI-RS, SSB, and/or DMRS of at least one of PDCCH and/or PDSCH.

In some embodiments, the QCL source for the aTRS derived based on the indicated TCI state may be CSI-RS and/or SSB.

In some embodiments, the QCL source for the aTRS derived based on the activated TCI state may be CSI-RS and/or SSB.

In some embodiments, the QCL source for the aTRS may be CSI-RS, SSB, and/or DMRS of PBCH.

In some embodiments, a TRS may be semi-persistent (SP). In some embodiments, an activation command for the TRS may be provided via DCI signaling.

In some embodiments, an aTRS may comprise a dynamically variable BW. For example, the dynamically variable BW may be at least partially configured (e.g., controlled) by a DCI message. In some embodiments, a DCI message may comprise an indication of the BW used for the TRS. In some embodiments, the dynamically variable BW may be at least partially configured by an RRC message. In some embodiments, one or more codepoints of the DCI may indicate at least one of a default BW and/or a first BW configured for the aTRS. In some embodiments, one or more codepoints of the DCI may indicate a second BW configured for the aTRS. In some embodiments, one or more codepoints of the DCI may indicate a third BW configured for the aTRS. In some embodiments, one of more codepoints of the DCI may indicate any number of BWs configured for an aTRS. In some embodiments, one or more codepoints may indicate one or more BWs preconfigured by the RRC message. In some embodiments, the DCI message triggering the aTRS may not schedule PDSCHs. For example, the PDSCH resource allocation field may be reinterpreted to indicate that the BW for the aTRS is determined based on the PDSCH resource allocation provided by the DCI message. In some embodiments, the BW for the aTRS may be determined based on at least one field of the DCI message. In some embodiments, the BW of the aTRS may be configured (e.g., controlled) by a MAC CE indication. For example, the MAC CE indication may comprise a field referring to a configuration ID of the aTRS and/or BW codepoint indication.

In some embodiments, if a terminal device is configured with a maximum scheduling BW, the default BW of an aTRS may be adapted based on the configured maximum scheduling BW. For example, the maximum BW may be a DL BWP BW, the current scheduling BW, and/or another BW.

In some embodiments, one or more time domain properties of a TRS, additionally or alternatively to a BW indication, may be varied. In some embodiments, a field of a DCI message may indicate whether one or more time domain properties and/or one or more BWs may be varied for the TRS. In some embodiments, the DCI message may indicate that an applied periodicity for an SP TRS transmission should be varied. In some embodiments, the DCI message may indicate that an applied periodicity and a BW for an SP TRS transmission should be varied. In some embodiments, the DCI message may deactivate an SP TRS transmission.

In some embodiments, a terminal device may receive a DCI message triggering an aTRS. In some embodiments, the terminal device may receive information comprising one or more adaptation indications for an SP TRS, wherein the one or more adaptation indications comprise at least one of BW indications or periodicity indications. In some embodiments, the terminal device may change, based on the one or more adaptation indications, at least one of the BW or the periodicity. In some embodiments, the terminal device may track, based on a reduction of periodicity or an increase in BW, at least one of time or frequency of a channel. In some embodiments, the terminal device may indicate, prior to the changing, an increased modulation and coding scheme (MCS) based on one or more conditions of the channel.

Various embodiments of the present disclosure may provide for various advantages including at least one of the following advantages: improving energy efficiency by using non-periodic transmission for reference signals; improving resource usage by using variable transmission parameters; increasing energy savings by enabling aperiodic transmission of TRS, wherein the TRS is usable by a plurality of terminal devices; increasing network scheduling flexibility; and/or other advantages.

Even though certain embodiments have been described above with reference to an example according to the accompanying drawings, it is clear that the disclosure is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

What is claimed is:

1. An apparatus comprising:
at least one processor; and
at least one memory storing instructions that, when executed by the at least one processor, cause the apparatus at least to perform:
receiving, by a terminal device and from a network device, a downlink control information (DCI) message triggering a semi-persistent tracking reference signal (spTRS);
receiving, by the terminal device, information comprising one or more adaptation indications for the spTRS, wherein the one or more adaptation indications comprise at least one of bandwidth (BW) indications or periodicity indications;
changing, based on the one or more adaptation indications, at least one of the BW or the periodicity; and
tracking, based on a reduction of periodicity or an increase in BW, at least one of time or frequency of a channel.

2. The apparatus of claim 1, wherein the instructions, when executed by the at least one processor, further cause the apparatus at least to perform:
indicating, by the terminal device and prior to the changing, an increased modulation and coding scheme (MCS) based on one or more conditions of the channel.

3. The apparatus of claim 1, wherein the apparatus is a terminal device.

4. A method comprising:
receiving, by a terminal device and from a network device, a downlink control information (DCI) message triggering a semi-persistent tracking reference signal (spTRS);
receiving, by the terminal device, information comprising one or more adaptation indications for the spTRS, wherein the one or more adaptation indications comprise at least one of bandwidth (BW) indications or periodicity indications;
changing, based on the one or more adaptation indications, at least one of the BW or the periodicity; and
tracking, based on a reduction of periodicity or an increase in BW, at least one of time or frequency of a channel.

5. The method of claim 4, further comprising:
indicating, by the terminal device and prior to the changing, an increased modulation and coding scheme (MCS) based on one or more conditions of the channel.

6. The method of claim 4, wherein an apparatus implementing the method is a terminal device.
